(19) United States
(12) Patent Application Publication
(10) Pub. No.: US 2026/0120342 A1
(43) Pub. Date: Apr. 30, 2026

(54) CONTENT SEARCH AND GENERATION ASSISTANT

(71) Applicant: GOOGLE LLC, Mountain View, CA (US)

(72) Inventors: Yuncheng Shen, Sunnyvale, CA (US); Donny Chen Reynolds, Mountain View, CA (US); Ryosuke Matsumoto, Dublin, CA (US); Mehrab Norouzitallab, Frenchs Forest (AU); Sarah Chou, San Francisco, CA (US)

(21) Appl. No.: 19/373,562

(22) Filed: Oct. 29, 2025

Related U.S. Application Data
(60) Provisional application No. 63/713,223, filed on Oct. 29, 2024.

(51) Int. Cl. G06T 11/00; H04L 51/04; H04L 51/10

(52) U.S. Cl. CPC G06T 11/00; H04L 51/04; H04L 51/10

(57) ABSTRACT

A method may in response to receiving input in an input area of a user interface configured to provide content to application, parsing the input to identify a content request and a generation request. A method may identify a first content item based on the content request. A method may cause generation of a second content item by a model, which uses the first content item and the generation request as input. A method may provide the second content item to an application.

### CROSS-REFERENCE TO RELATED APPLICATION

This application claims priority to U.S. Provisional Patent Application No. 63/713,223, filed on Oct. 29, 2024, the disclosure of which is incorporated by reference herein in its entirety.

### BACKGROUND

Presently, users can amend content by searching for original content, potentially in a first application, and modifying the content in potentially a second application. Such operations may use a clipboard to temporarily store the content.

### SUMMARY

A user interface and methods are disclosed for generating content based on prior content using a single request from a user. The disclosed user interface and methods improve computer functionality by implementing a novel data processing pathway. For example, the system receives a request and parses the request into distinct operational vectors; one for content retrieval, i.e., a content request and another for content generation, i.e., a generation request. Content is identified based on the content request, for example by searching a user's local files or cloud storage. Content is then generated by a model using the identified content and the generation request as input. The generated content is then provided to a user, for example, within a user interface where it can be inserted into an application, thereby improving operational efficiency of the computing device.

In some aspects, the techniques described herein relate to a method including: in response to receiving input in an input area of a user interface configured to provide content to applications, parsing the input to identify a content request and a generation request; identifying a first content item based on the content request; causing generation of a second content item by a model, which uses the first content item and the generation request as input; and providing the second content item to an application.

In some aspects, the techniques described herein relate to a system including: a processor; and a memory configured with code operable to: in response to receiving an input in an input area of a user interface configured to provide content to applications, parse the input to identify a content request and a generation request from the input; identify first content item based on the content request; cause generation of second content item by a model using input that includes the first content item and the generation request; and provide the second content item to an application.

In some aspects, the techniques described herein relate to a non-transitory computer-readable medium storing instructions that, when executed by a processor, cause the processor to: in response to receiving an input in an input area of a user interface configured to provide content to applications, parse the input to identify a content request and a generation request from the input; identify first content item based on the content request; cause generation of second content item by a model using input that includes the first content item and the generation request; and provide the second content item to an application.

In some aspects, the techniques described herein relate to a method including: parsing an input to identify a content request and a generation request from the input; identifying first content item based on the content request; causing generation of second content item with a model using input including the first content item and the generation request; and providing the second content item to an application.

In some aspects, the techniques described herein relate to a system including: a processor; and a memory configured with code operable to: parse an input to identify a content request and a generation request from the input; identify first content item based on the content request; cause generation of second content item with a model using input including the first content item and the generation request; and provide the second content item to an application.

In some aspects, the techniques described herein relate to a non-transitory computer-readable medium storing instructions that, when executed by a processor, cause the processor to: parse an input to identify a content request and a generation request from the input; identify first content item based on the content request; cause generation of second content item with a model using input including the first content item and the generation request; and provide the second content item to an application.

### BRIEF DESCRIPTION OF THE DRAWINGS

FIG. 1 depicts an application with an input area, according to examples described throughout this disclosure.

FIG. 2 depicts an example of how a user may trigger an example user interface, according to examples described throughout this disclosure.

FIG. 3 depicts an example of how a user interface may display upon launch, according to examples described throughout this disclosure.

FIG. 4 depicts an example of how a user may use the user interface to generate content, according to examples described throughout this disclosure.

FIG. 5 depicts an example of how content generated with a user interface may be inserted into an application, according to examples described throughout this disclosure.

FIG. 6 depicts an example of how the user interface may be used to generate further content, according to examples described throughout this disclosure.

FIG. 7 depicts an example block diagram of a method, according to examples described throughout this disclosure.

FIG. 8 depicts an example block diagram of a method, according to examples described throughout this disclosure.

FIG. 9 depicts an example system, according to examples described throughout this disclosure.

### DETAILED DESCRIPTION

The disclosure provides a specific computing architecture that integrates a natural language parsing engine with a content retrieval module and a generative AI model. this architecture creates a direct, in-process data pipeline that allows a retrieved data object, referred to as ‘first content item’, to be passed directly to the generative model as a memory object or pointer, along with generation or modification instructions, referred to as ‘a generation request’ for that content. The AI model can then create generated content and provide it for insertion into another application. This configuration reduces computational overhead and provides a more efficient human-computer interaction for content creation and modification.

An input is an explicit communication from a user to a computing system or intelligent agent, including data (e.g., natural language text, keywords, or multimedia inputs) that serves to direct the system's output, often soliciting a specific response, action, or retrieval of information. In examples, an input may be a request, query, or a prompt. An input may include a first portion identifiable as a content request for identifying source content and a second portion identifiable as a generation request for altering the source content. The input may be provided as a single, contiguous string of natural language text. The input may be parsed to identify and separate its distinct semantic components including content request and a generation request, which may be performed by a model configured to interpret a user's intent.

Content may include any combination of image, text, audio, or video content. Content can be related to a web page, an image file, a video file, a text file, a document file, a spreadsheet, a presentation, an executable file, etc., or any combination thereof. A content request includes the one or more terms of the input that may be used to search for or identify content to be generated or modified. The content request may identify potential content to be identified, by including terms, phrases, images, audio, or semantic indicators related to the desired content. The content request may be used to identify specific subject matter (e.g., a person or a report type) associated with the content. The content request may be used to identify circumstances associated with the content (e.g., content created at a specific location or a type of location, or content created with a mobile phone). A content request may be used to identify other metadata generated by the user or associated with the content (e.g., a favorite tag). In examples, the content request may be used to identify concepts represented in or by content. This description of what the content request may be used to identify is not exclusive, in examples the content request may be used to identify any concept in content. A content corpus may refer to the collection of digital assets associated with or accessible by a user from which content may be identified. In examples, one or more content corpuses may be searched to identify content based on the content request. A content corpus may comprise one or more repositories, such as file directories, browser histories, social media content, photo libraries, and cloud storage accounts, and may be stored across a local device, network-accessible servers, or third-party services.

A generation request is the portion of the input that specifies the alterations to be performed on the identified source content. As used herein, a “model” refers to any computational system, including but not limited to machine learning models, generative models, language models, foundational models, mixed mode models, or other AI systems, configured to process input data and generate an output, such as new or modified content.

At least one technical problem with current computing systems is that the process needed to find and modify content is lengthy and inefficient. First, users must identify the content. With user permission, one or more searches of one or more file directories, browser histories, social media repositories, photo directories, or any document repository may be used to identify content. In examples, the document repository may be associated with the user. Once content is identified that content must be accessed via an application operable to edit the content. Once the content is generated/modified/edited, it can be saved for later use. Such context switching between windows and manually locating the content causes user friction and may be particularly problematic for users having reduced dexterity and/or manual capabilities, which can make effective interaction with their device more difficult. In addition, such conventional workflows are computationally expensive, using additional processor cycles and requiring the operating system to launch separate processes for searching and editing, each of which loads distinct executables into volatile memory. This process involves multiple disk I/O operations to read the content, followed by utilization of the system clipboard. The use of the clipboard itself introduces further overhead, including data serialization to a common format, temporary storing in system memory, and inter-process communication to transfer the serialized data, all of which consume significant CPU cycles, memory bandwidth, and electrical power. The process takes time, and moving away from the primary application to identify and generate content can create distractions for a user. Opening additional application windows takes up space on a display and can create distractions for a user. A user often must clean up again after, for example by closing browser tabs or applications accessed to find the content.

One technical solution proposed in the disclosure is to provide a computing environment that enables a user device to parse a single input from a user to identify a content request and a generation request from and then create generated content based on the identified content and the generation request using a model. The generation request may include any input to modify or generate new content based on pre-existing content. A generation request may include any changes, additions, or subtractions to an image, text, audio or video file. Examples of modifications that a generation request may make include: changing a file size, colors, compression, applying a filter, cropping, redrawing, re-rendering, and so forth. In examples, a generation request may also include an input to generate a new format of content based on another format (e.g., generating new audio content including a voice reading words from a preexisting text file).

In some implementations, a user interface for providing the input may be supplied by the operating system, which makes the user interface launchable when using any application. The user interface can also be provided by a particular application. The user interface allows users to do any combination of entering the input, identifying, generating, and inserting content. In examples, the user interface has ways to search for additional content to further generate or modify content or to iteratively modify content.

The technology described herein can enable a user to create content that is personalized based on other content that a user has accessed. The methods may further help a user interact with their device more efficiently, for instance by enabling them to generate content more efficiently. As mentioned above, this may be particularly useful for users having reduced dexterity and manual capabilities, which can make effective interaction with their device problematic. For instance, the technology described herein may reduce the need for users to switch between applications in order to locate content, open content, and manually generate content for use in another application.

In addition, the user interfaces described provide an improved guided human-machine interaction process that generates content based on prior content from a single user input, thereby conserving computing resources by eliminating the need to navigate to separate search windows or applications operable to edit the content. Because the methods described use fewer user inputs, windows, threads, processes, and window focus changes, they reduce the use of processing resources on device and the number of interactions with the device to complete the task of adding content from another application to an input area in the current application. The user interfaces described herein may also allow a user to operate with fewer windows open on a desktop, using less desktop space, thereby reducing friction. In examples where the display of the user interface may be triggered by a predetermined gesture, such as keyboard key, using the user interface to insert information may reduce the number of times that a user must go between input devices, such as the keyboard and a mouse.

Furthermore, this streamlined process improves the functioning of the computing device by reducing power consumption and providing a more direct and efficient data pathway. This pathway avoids the inherent limitations of a generic system clipboard, which is constrained to handling a single data item at a time, often forces data into standardized formats that can result in data loss, and introduces latency and resource consumption from writing to and reading from a clipboard buffer. By contrast, the disclosed architecture passes data directly between the content retrieval module and the generative model within system memory, eliminating clipboard-related overhead and preserving the integrity of the data.

In the figures, example application 100 is depicted as a chat application for ease of discussion and illustration, but implementations are not limited to a particular application. Any application into which an input or content may be inserted is contemplated. Application 100 may be any application that allows a user to create, access, edit, save, or send content, for example: a word processing application, a social media application, an illustrator application, an image or video editing application, a spreadsheet application, or an email application, in addition to others.

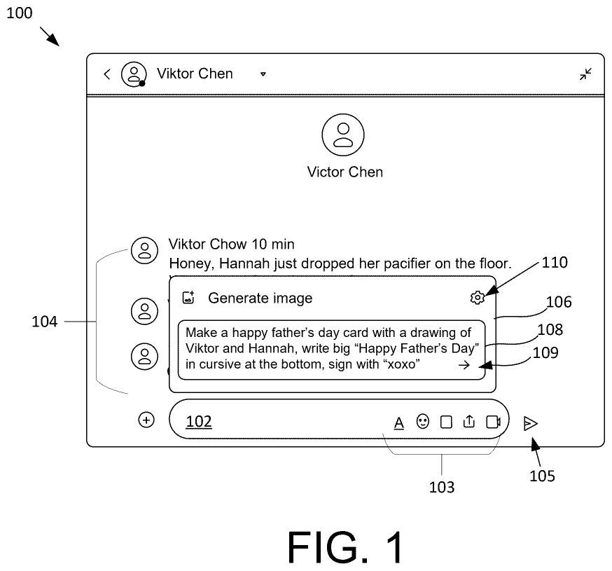

As may be seen in FIG. 1, application 100 includes an input area 102. An input area is a user interface element in an application where content can be interacted with via any combination of adding, editing, and/or deleting activities. In examples, input area 102 may accept any combination of text (including rich text), image, hyperlink, audio, and/or video. Example input area 102 of application 100 allows a user to send a message to another user, but in further examples input area 102 may allow a user to create a social media post, edit a document, provide a field value to a form, or to otherwise access, edit, or save content.

In examples, input area 102 may be associated with one or more insert controls 103, depicted inside input area 102 in the figure. In examples, the one or more insert controls 103 may include controls to modify the font of text typed into input area 102, to insert emoji, to take a picture for insertion, to insert a file, to take a video, and so forth.

In examples, content entered into input area 102 may be sent to another user via application 100 upon selecting a send control 105, depicted as a sideways arrow in FIG. 1. In examples, content entered into input area 102 may be sent to another user by pressing an enter key on the keyboard.

In the example, application 100 includes a message history section 104. Message history section 104 includes a history of the messages and content that have been sent between the device user and at least one other user. FIG. 1 further depicts an assistive input user interface 106. In examples, assistive input user interface 106 may be used to identify, modify, and/or create content. In examples, the generated content may be inserted into input area 102 of application 100. In examples, assistive input user interface 106 may be provided by an operating system. With user permission, assistive input user interface 106 may allow a user the ability to access content across applications, file directories, and/or the operating system without moving focus away from application 100. In other words, focus may be maintained by an application while the assistive input user interface 106 is used to identify and generate content without giving focus to another application.

In examples, input area 102 of the application 100 has focus when the cursor is within a text area of the application 100. Put another way, input area 102 of the application 100 has focus when input (text entered, click input, touch input, etc.) passed from the operating system to the application 100 will be entered into the input area.

In examples, assistive input user interface 106 may appear over and/or beside application 100. In examples, assistive input user interface 106 may remain on top. In other words, user interface elements of application 100 may not cover any portion of assistive input user interface 106.

In examples, components of application 100 may further have focus within application 100. For example, when a cursor is inside input area 102, input area 102 may have focus.

In examples, the display of assistive input user interface 106 may be triggered via a variety of user actions. In examples, the display of assistive input user interface 106 may be triggered by right clicking, for example over input area 102, via a control on a task bar, via the start menu, via an application menu, or via any other method. While the example of triggering the display of assistive input user interface 106 by actuating a keyboard key is discussed throughout the rest of this disclosure, this is not intended to be limiting. In examples, other user input gestures may be used to trigger the display of assistive input user interface 106.

Assistive input user interface 106 may include one or more components. For example, assistive input user interface 106 may include an input field 108 operable to receive an input (e.g., a request) to identify/find a file or generate content from the device user. In examples, any combination of entering text into input field 108, pressing enter, or pressing a content generation control 109 (depicted as an arrow that may be clicked via a mouse) may initiate the process of generating content, as is further described below.

In examples, assistive input user interface 106 may include a setting control 110 operable to access one or more controls relating to assistive input user interface 106. In examples, setting control 110 may allow a user to select one or more controls relating to what data may be accessed by assistive input user interface 106 to generate content in response to an input. For example, setting control 110 may allow a user to select one or more controls relating to access to files or content associated with a user from: a file directory, browser history, or social media, in addition to others.

In examples, assistive input user interface 106 may initiate a response to an input that prioritizes content relating to files with certain access attributes. An access attribute is a feature of how a file has been accessed in the past, and in some examples it may be captured by metadata associated with a file. With user permission, the access attribute may include any combination of the following non-exclusive list: a timestamp, a user identity, a resource identifier, an action type, a duration, a device type, and so forth. In examples, the access attribute may indicate that a file has been accessed by a user within a recency threshold (e.g., a time threshold or time horizon). The recency threshold may be set by the user or a default may be applied (for example, via an application or the operating system) that represents a time period such as, for example, a week, two weeks, or a month.

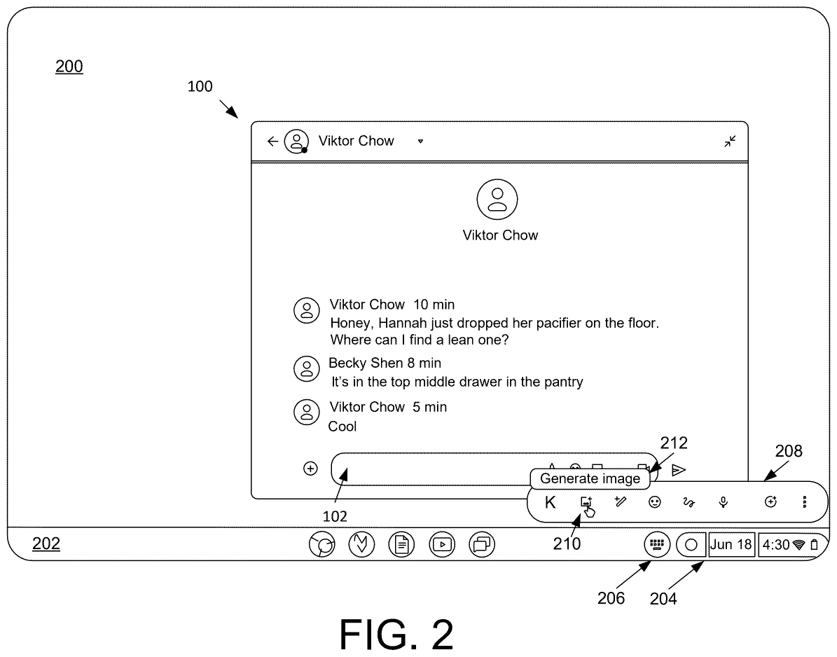

FIG. 2 depicts an example of how a user may trigger the display of assistive input user interface 106 while using application 100. FIG. 2 depicts a desktop 200 around application 100. Elements of desktop 200 may be provided by the operating system, such as a taskbar 202 with a notification area 204.

In the example, taskbar 202 is positioned adjacent to the bottom of desktop 200 and notification area 204 is positioned at a right end of taskbar 202. In examples, any placement of taskbar 202 and notification area 204 is possible around taskbar 202.

In examples, taskbar 202 may further include an application selector control 206. Application selector control 206 may be selected (for example by mouse click) to launch an application selection window 208. Application selection window 208 may include icons representing selectable controls operable to launch an application. Selectable control 210 may be operable to launch application 100. In examples, upon determining that a mouse over hovers selectable control 210, the operating system may initiate the display of a text bubble 212 explaining what function(s) selectable control 210 is operable to initiate. In the example, text bubble 212 reads, “Generate image.”

In examples, taskbar 202 may include selectable control 210, which may be selected to trigger the display of assistive input user interface 106. In examples, assistive input user interface 106 may be triggered to display via a menu control (for example a menu within application 100), or via a right-click menu.

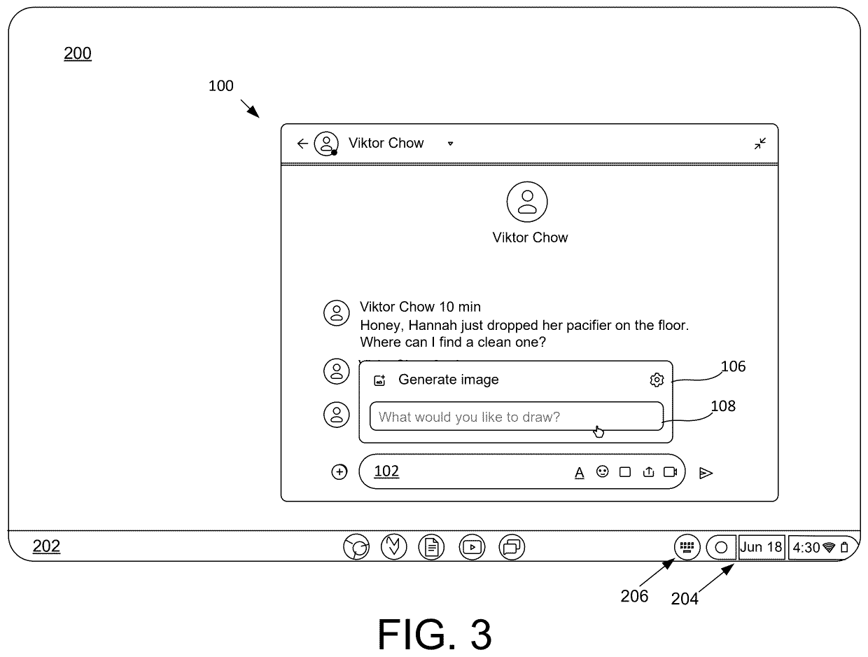

FIG. 3 illustrates an example user interface triggered by selection of selectable control 210, according to an implementation. For example, assistive input user interface 106 may be displayed in response to selection of selectable control 210. In examples, input field 108 may include text prompting a user to take an action, such as “What would you like to draw?” In examples, the text may be grayed out to distinguish it from an actual input by a user. When assistive input user interface 106 is displayed, application selection window 208 may disappear from (be removed from) display on desktop 200.

In examples, the display of assistive input user interface 106 may be triggered via other input gestures. In examples, the input gesture may be a dedicated gesture. Put another way, in such examples the predetermined gesture may be always associated with the user interface and configured to always trigger the display of the user interface when detected. In some examples, the user interface may be triggered in other ways, such as by any combination of right click, menu control, gesture, etc. The user interface provides a way to generate content or modify content based on existing content without opening or giving focus to additional applications (e.g., the applications associated with the sources/recently accessed content).

In some examples, the input gesture may be associated with the user interface as a dual-function input gesture. More specifically, the dual function input gesture may be used to trigger the display of the user interface if an input area has focus or may be used to perform another default operation in response to actuation if an input area lacks focus (i.e., does not have focus). Using the example of a keyboard caps-lock key, the key may be used to either trigger the display of the user interface or toggle the caps-lock function of the keyboard.

While the example of launching assistive input user interface 106 while application 100 has focus has been provided, in examples assistive input user interface 106 may be launched when no application has focus.

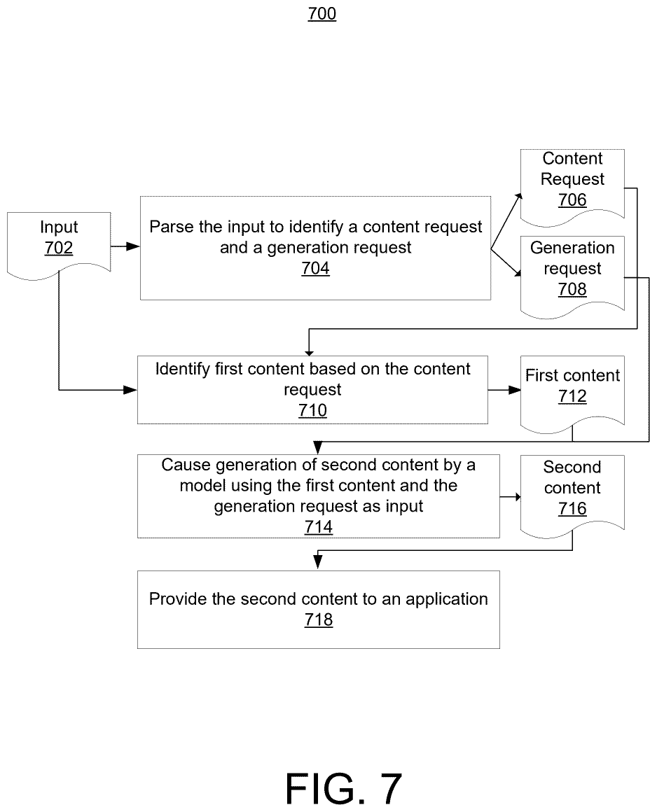

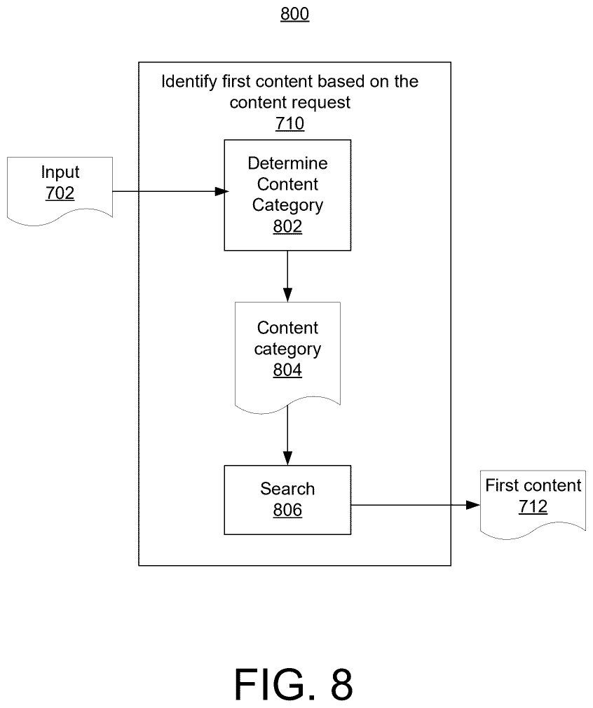

In the example of FIG. 1, a user has entered the input, “Make a happy father's day card with a drawing of Viktor and Hannah, write big, ‘Happy Father's Day’ in cursive at the bottom, sign with ‘xoxo’”. Upon receiving the input within input field 108, assistive input user interface 106 may initiate the generation and display of content. How the content is generated/modified and displayed is further described with respect to FIGS. 7 and 8 below.

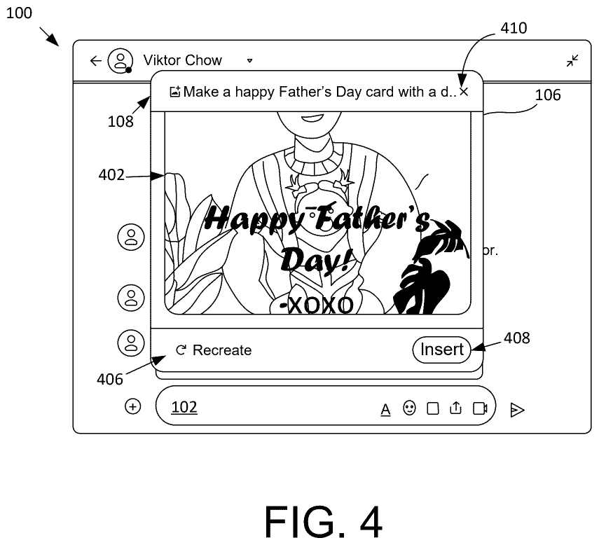

Turning to FIG. 4, it may be seen that generated content 402 has been created based on the input entered into input field 108 of FIG. 1. In the example of FIG. 4, generated content 402 includes a drawing based on a photo found in a photo repository associated with the user. The drawing includes the text, “Happy Father's Day” in cursive and “-xoxo” overlaid at the bottom responsive to the input, “write big, ‘Happy Father's Day’ in cursive at the bottom, sign with ‘xoxo’”. While generated content 402 depicted in FIG. 4 comprises a preview, or a small version of the generated content 402, which may comprise any combination of image, text, audio, or video content.

In FIG. 4, input field 108 is still displayed within assistive input user interface 106. In examples, the input text used to create generated content 402 may still be displayed within input field 108 for user reference. If the user wishes to enter a new input, the user may generate the previous input or enter a new input, for example by selecting an input reset control 410 and entering a new input into input field 108.

Generated content 402 is not completely visible in the figure. In examples, the user can use an input device, such as a mouse, a gesture, a trackpad, etc., to scroll from the top to the bottom of generated content 402.

In examples, assistive input user interface 106 may display other controls relating to generated content 402. For example, assistive input user interface 106 may include a recreate control 406. Recreate control 406 may be operable to initiate the creation of a further version of generated content based on the same or different content identified from the request. For example, the recreate control 406 may create an additional generated content based on the first content item identified using the content request or based on a second content item identified using the content request.

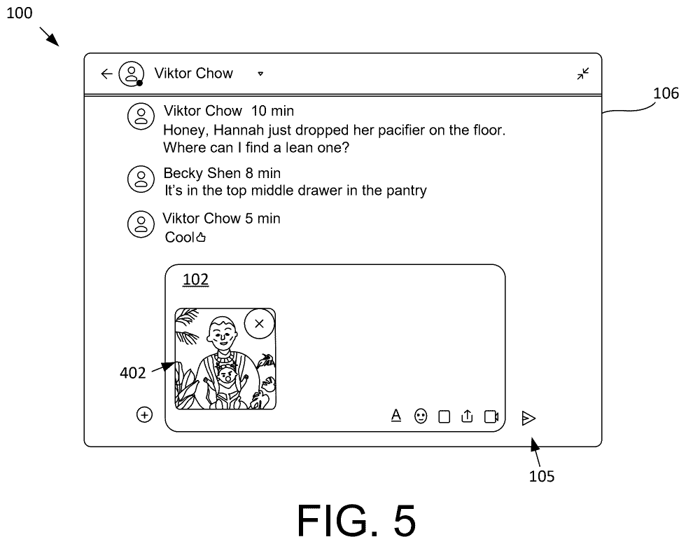

In examples, assistive input user interface 106 may include an insert control 408. Upon selection, insert control 408 may be operable to initiate the insertion of generated content 402 into a field of an application that had focus before assistive input user interface 106 was launched, such as input area 102 of application 100 for example. In examples, the generated content 402 may include a full view or a preview of the generated content 402. In examples, the generated content 402 may itself be a selectable option operable to initiate the insertion of the generated content 402 into a field of an application. FIG. 5 illustrates an example result of selection of the insert control 408 of FIG. 4.

In FIG. 5, insert control 408 has been selected and generated content 402 has been inserted into input area 102. After insertion, assistive input user interface 106 may no longer be displayed. In examples, the user may press ENTER or send control 105 to send generated content 402 to another user in the chat.

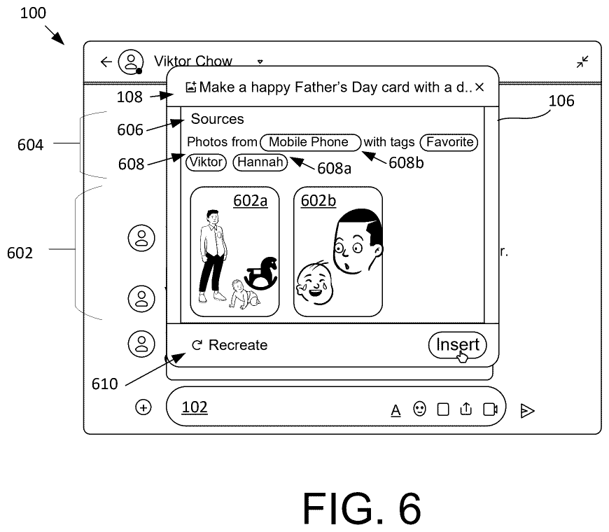

Turning to FIG. 6, in examples assistive input user interface 106 may further include a content suggestion section 602. Content suggestion section 602 may include one or more instances of selectable content controls 602a, 602b associated with other identified content present in a repository associated with a user. In the example, two selectable controls are displayed, but any number of selectable controls may be possible.

Selectable content controls 602a, 602b may be configured to select content associated with a user to modify with the generation request identified from the input. In the example, selectable content controls 602a, 602b may be associated with content saved in a directory internal to a device memory or available via a network, such as the Internet.

In examples, selectable content controls 602a, 602b may be associated with a content category identified from the input. A content category may include one or more content qualifications, such as content type (e.g., image, audio, textual, video, etc.), content subject matter, (e.g., cats, friends, location coordinates, beach, event, etc.), a content repository (e.g., social media, on device, cloud storage, photo library, audio library, etc.), content creation date, and/or any other criteria by which may be used to classify content into or out of a category. For example, the input from FIG. 1 asks for a drawing with Viktor and Hannah. In response to this input, assistive input user interface 106 may initiate a search for images including Viktor and Hannah that can be turned into drawings.

Assistive input user interface 106 may further include a content source information section 604. Content source information section 604 may be operable to describe and/or allow selection of categories, criteria, and/or one or more content corpuses that may be used to select content to generate generated content 402. A content corpus may include one or more associations of content. In examples, the content source information section 604 may include selectable content controls 602a, 602b. In examples, content source information section 604 may include a title 606, for example title 606 is “Sources” in the example. Content source information section 604 may further include a content description 608 about how content is being selected, including any combination of information about a content category, a content source (e.g., mobile phone or with favorite tags), and/or search criteria used (such as metadata or tags). In FIG. 6, content description 608 reads, “Photos from Mobile Phone with tags Favorite Viktor Hannah. In examples, one or more of the terms in content description 608 may be displayed as a content category selection control 608a. Upon selection, the 608a//For example, content category selection control 608a is displayed with a border around it so that it presents like a button. In the example, selecting content category selection control 608a may toggle the source, Mobile Phone, off and on. Upon selection of other content category selection controls, elements of the content category and/or criteria may toggle off or on.

Once a user selects any selectable control from content suggestion section 602, it may be possible to regenerate the generated content 402 again based on the newly selected content. For example, in FIG. 6 assistive input user interface 106 includes a modify content control 610, labeled, “Recreate” in the example. Upon user selection, modify content control 610 is operable to initiate the generation of further generated content based on which selectable content control 602a, 602b is selected.

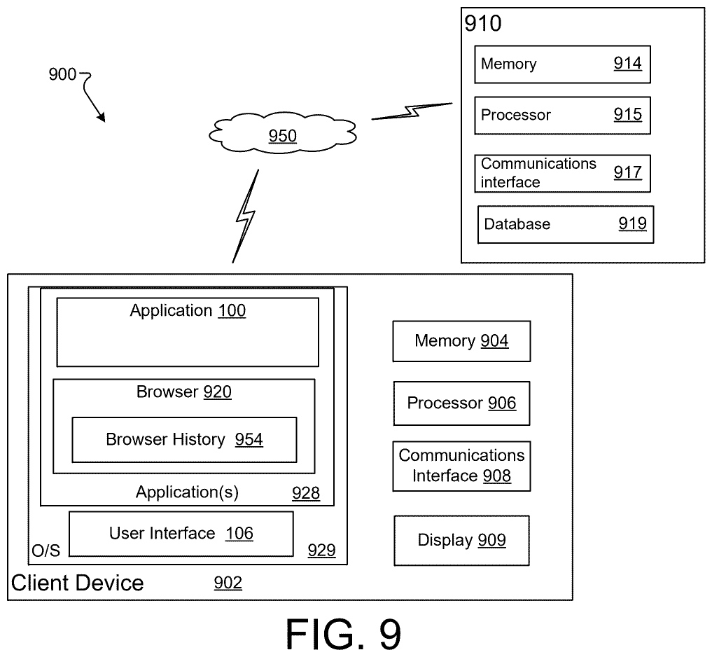

FIG. 7 depicts a method according to some implementations. FIG. 7 depicts a block diagram of a method 700, which may be used to create generated content based on an input. For example, method 700 may be used to generate the generated content 402 of FIG. 4. In examples, method 700 may include any combination of steps 704, 710, 714, and 718. Method 700 can be executed by any combination of the client device and/or server device described with respect to FIG. 9 below.

Method 700 may begin with step 704. In step 704, in response to receiving input in an input area of a user interface configured to provide content to applications, the input may be parsed to identify a content request 706 and a generation request 708. For example, input may be received at input field 108 to generate a father's day card, as is described above.

Method 700 may continue with step 710. In step 710, first content item 712 may be identified based on the content request 706. For example, a photo of Viktor and Hannah, may be identified, as described above.

Method 700 may continue with step 714. In step 714, second content item 716 may be generated by a model using the first content item 712 and the generation request 708 as input. For example, the father's day card generated content 402 depicted in FIG. 4 may be generated, as described above.

Method 700 may continue with step 718. In step 718, the second content item 716 may be provided to an application, e.g., a user interface of an application. For example, generated content 402 may be provided in input area 102, as depicted in FIG. 5 and described above.

Further use cases to apply the methods described herein may include a request to write a funny invitation for a social activity on a first social media site based on inside jokes from a second social media site. In examples, the display of assistive input user interface 106 may be initiated from within the first social media application. Step 704 may, with user permission, be executed by using an application programming interface (API) call to the second social media site to identify content relating to inside jokes between the user and their connections. The invitation with the joke, which constitutes the generated content, may then be inserted directly into an input area in the first social media application. This demonstrates a cross-application data synthesis capability, where content is sourced from one service to create new, contextualized content for another, without requiring the user to manually switch between applications or copy and paste information. The system may parse the user's natural language request, identify the relevant social media platforms as both the source and destination, retrieve pertinent conversational data (inside jokes), and generate a new piece of content that is tonally and contextually appropriate for the specified social activity and audience.

For instance, a user composing a post on a first social media platform to organize a weekly game night might enter the input, “Draft a funny invite for our game night using our running jokes from our group chat on the second social media platform.” The system would parse this input to identify the content request (“running jokes from our group chat on the second social media platform”) and the generation request (“Draft a funny invite for our game night”). To fulfill the content request, the system could make an API call to the second social media platform, with user permission, to search the user's group chat history for recurring phrases, memes, or conversational threads that have high engagement (e.g., numerous replies or reactions), which are indicative of inside jokes. The generation request would then be processed by a generative model, which takes the identified inside jokes as source material and crafts a humorous invitation. The resulting invitation might read, “Attention all ‘Level 5 Wizards’! It's time for our weekly game night. Let's hope no one rolls a ‘critical failure’ like last week's pizza incident. Be there or be square . . . or be a ‘gelatinous cube’!” This generated text, which incorporates the identified inside jokes, could then be provided within the assistive input user interface for insertion into the post on the first social media platform.

This process may significantly enhance user efficiency by automating the complex task of recalling and transcribing contextual social information, reducing the cognitive load on the user, who no longer needs to remember specific jokes or navigate to a separate application to find them. From a system perspective, this implementation may conserve resources by executing a targeted API call for specific data rather than requiring a broad, power-intensive search across multiple applications or data stores. Furthermore, the direct insertion of the generated content into the target application streamlines the workflow, preventing the data fragmentation and potential formatting issues associated with manual copy-and-paste operations. This cross-platform integration exemplifies a sophisticated human-computer interaction that leverages contextual data from disparate sources to create highly personalized and relevant content in a seamless manner.

A further use case may include using a user's handwriting from a scanned document and a group selfie photograph to draw personalized stickers for wishing another user a happy birthday. In this scenario, a user might provide the input, “Create a happy birthday sticker for Alex using my handwriting from my scanned notes and our group selfie from the beach trip.” The system would parse this request to determine the content to be identified: the user's handwriting style from a specified source (“scanned notes”) and a specific group photograph (“group selfie from the beach trip”). The generation request would be to generate a “happy birthday sticker for Alex.”

To execute step 704, the system may first search the user's local or cloud-based document repositories for files tagged as “scanned notes” or containing images that an optical character recognition (OCR) and handwriting analysis model could identify as handwritten text. Once a sample of the user's handwriting is located, a style model may be trained or adapted to replicate its unique characteristics, such as slant, letter formation, and ligature. Concurrently, the system may search the user's photo library, filtering for images that contain the user and the person named Alex, and further filtering by location metadata or user-provided tags like “beach trip” to locate the specified group selfie.

In step 714, a generative image model may synthesize these disparate elements. It may take the identified group selfie as the base image. It may then apply an artistic filter to give it a more sticker-like appearance, such as adding a bold outline or simplifying the color palette. Crucially, the model may overlay the text “Happy Birthday, Alex!” onto the image, rendering the text in the user's unique handwriting style that was learned from the scanned document. The final output, a highly personalized digital sticker, may then be provided in the assistive input user interface 106. This example showcases the system's ability to combine stylistic attributes (handwriting) with visual content (photographs) from entirely different file types and sources to create a novel piece of composite media, providing a level of personalization that would be extremely difficult and time-consuming to achieve manually.

Further use cases to apply the methods described herein may include composing a tweet with an inline summary of an article read on a browser earlier that day. A user, intending to share an interesting article on a social media platform, could enter the input, “Tweet a link to that article I read this morning about AI in healthcare and include a short summary.” The system may parse this input, identifying the content request as “that article I read this morning about AI in healthcare” and the generation request as “Tweet a link . . . and include a short summary.”

To identify the content (step 704), the system may, with user permission, access the user's browser history from that day. It may filter the history for URLs visited within a specified time window (“this morning”) and search the page titles, metadata, or cached content of those URLs for keywords such as “AI” and “healthcare.” Once the correct article is identified, its URL becomes the primary piece of content.

For the modification step (step 714), a generative language model may be employed. The model may receive the full text content of the identified article as input. It may be instructed by the generation request to perform two actions: first, to generate a concise summary of the article's key points, and second, to format the output as a tweet, which implies adhering to a character limit and adopting a suitable tone for the platform. The resulting generated content 709 may be a string of text such as: “Fascinating read on how AI is revolutionizing healthcare diagnostics. The latest models can detect diseases earlier and more accurately than ever before. [URL to article] #AI #HealthTech”. This generated text, combining the summary and the link, may be presented in the assistive input user interface 106, ready for one-click insertion into the social media application's input field. This process may save the user from the cumbersome steps of finding the article link, re-reading it to create a summary, and manually typing out the post, thereby streamlining the content sharing workflow.

A further use case may apply the methods described herein to generate a voice track for a video to be posted on social media, with the narration based on text from a commerce website review. A user editing a short video of a new product could input, “Create a voiceover for my video using the top-rated review for this product from the commerce website.” Here, the content request is “the top-rated review for this product from the commerce website,” and the generation request is to, “Create a voiceover for my video.”

The system may first need to identify the product, which may be determined from context within the video editing application (e.g., project name, metadata) or by performing a visual search based on frames from the video itself. Once the product is identified, the system may execute a web search or use a dedicated API to query a popular commerce website for that product. It may then parse the product's review page to extract the text of the review with the highest rating (e.g., the most “helpful” votes or a five-star rating). This text may constitute the identified content 705.

In step 714, a text-to-speech (TTS) synthesis model may create the generated content. The model may take the extracted review text as input and convert it into an audio file (the voiceover). The user may have pre-selected a preferred voice, or the system could choose one with a tone appropriate for a positive product review. The resulting audio file (first generated content 709) may then be made available through the assistive input user interface 106. The user may insert this generated voice track directly into the audio timeline of their video project. This workflow may provide a powerful tool for content creators, allowing them to rapidly incorporate authentic social proof into their videos without having to manually record audio or navigate away from their editing software to find and copy review text.

Further use cases to apply the methods described herein may include writing a reminder to RSVP for a meeting based on a related event identified in a calendar application. A user in a messaging application might receive a message from a colleague asking, “Are you going to the project sync tomorrow?” The user could then invoke the assistive input user interface and type, “Write a reply saying I'll be there and create a reminder to RSVP.” The system parses this to identify two requests: a generation request to “Write a reply saying I'll be there,” and a content request embedded within the secondary task, “create a reminder to RSVP,” which implies the need to identify the relevant calendar event.

To identify the content (step 704), the system may, with user permission, access the user's calendar application. The calendar application may be searched for events scheduled for the next day (“tomorrow”) containing keywords from the conversation context, such as “project sync.” Upon finding the matching calendar event, the system may extract its details, such as the event title, time, and any notes, which may include the RSVP link or instructions. This calendar event data becomes the identified content 705.

The system may then create the generated content (step 714). First, it may generate a text reply for the messaging application, such as “Yes, I'll be there!” Second, using the identified calendar event details, it may interface with a task management or reminder application via an API. It may generate a new reminder with a title like “RSVP for Project Sync” and set a due time before the meeting. The assistive input user interface may then present two selectable options to the user: one to insert the text reply into the chat and another confirming that the RSVP reminder has been created. This example demonstrates the system's ability to act as a personal assistant, interpreting a single user request to perform actions across multiple applications (messaging, calendar, and reminders), thereby integrating communication and task management in a highly efficient and context-aware manner.

Further to the descriptions above, a user may be provided with controls allowing the user to make an election as to if and/or when user data (e.g., information about websites a user has viewed, user files, calendar events, social media content, etc.) may be accessed using the methods described herein, and if any of that user data may be sent to a server. In examples, some data may be treated in one or more ways before it is stored or used, so that personally identifiable information is removed. For example, a user's geographic location may be generalized where location information is obtained (such as to a city, ZIP code, or state level), so that a particular location of a user cannot be determined. Thus, the user may control what data is accessed and how that data is used.

FIG. 8 depicts a block diagram of method 800, which is one example implementation of step 710 from method 700, which includes identifying first content based on the content request. In examples, step 710 may include any combination of steps of method 800. In examples, method 800 may include any combination of steps 802 and 806. In examples, method 800 may begin with step 802. In step 802, input 702 may be received and a content category 804 may be determined.

In examples, content category 804 may be determined using a classifier, such as a machine learned classifier trained on a dataset of user queries and their corresponding intended content categories.

In examples, content category 804 may be determined using a model, such as a machine learning model or a generative model. In examples, the first user interface may include an additional prompt (e.g., determine the type of content needed to complete the request) to include in the input with the input. Alternatively, or in addition, few shot programing examples may be provided to the model demonstrating how to determine the content category 804. In examples, any combination of content type (e.g., text, image, video, audio, etc.), content subject matter (e.g., a picture of someone in particular, text relating to rainbows, etc.), and/or content source (e.g., device file directory, browser history, social media content, etc.). For example, for the input, “Make a happy father's day card with a drawing of Viktor and Hannah, write big, ‘Happy Father's Day’ in cursive at the bottom, sign with ‘xoxo’”, the content category 804 may be determined to be photos including Hannah and Viktor.

In examples, 804 may determine content category 804 from step 802 using a machine learning model. In examples, the machine learning model may be trained on a data set including queries and intended content categories.

In further examples, step 802 may determine content category 804 by providing input 702 to a generative model. A generative language model is a type of machine-learning model that uses deep learning to generate a response based on a prompt and a context. Language models are trained on vast amounts of data, typically in the form of text or speech, and can be configured (trained) to use this data to predict entities and/or entity types associated with webpages. Using prompts and context as inputs, language models generate outputs or responses. A prompt is an input to which the language model generates a response. Prompts can include instructions, questions, or any other type of input, depending on the intended use of the model. In examples, step 802 may apply a prompt such as, “determine the type of content needed to complete the input” along with input 702 to generate content category 804.

In examples, method 800 may continue with step 806. In step 806, a search may be performed using content category 804 as input to generate second content item 716. In examples, the search may include searching a directory for files that include input terms in filenames, content, and/or metadata. In examples, with user permission the search may include searching a browser history for content related to content category 804. In examples, the search may include using an API to request a social media website to find content related to content category 804.

FIG. 9 depicts a block diagram of system 900 that may execute the methods described herein, according to an example. System 900 includes a client device 902 and a server 910 in communication via a network or the internet 950.

Client device 902 includes a non-transitory memory 904, a processor 906, and a communications interface 908. Client device 902 is in communication with a display 909, which may be internal or external.

The client device 902 may include an operating system 929 upon which applications 928 may execute. Applications 928 represent specially programmed software configured to perform different functions, including creating, editing, and saving files with content. Assistive input user interface 106 may be a service provided by the operating system 929.

One of the applications 928 may include application 100. Another of the applications 928 may be the browser 920. The browser 920 may be configured to display webpages, execute web applications, and the like in one or more windows or tabs. Browser 920 further includes browser history 954, as described above.

The client device 902 may communicate with the server 910 over a network. Server 910 includes a non-transitory memory 914, a processor 915, a communications interface 917, and a database 919. The server 910 may store in the non-transitory memory 914 instructions that, when executed by the processor 915 cause the server 910 to perform operations, such as working with the client device 902 to generate information used to provide a comparison user interface.

The server 910 may be a computing device or computing devices that take the form of a standard server, a group of such servers, or a rack server system. In some examples, the server 910 may be a single system sharing components such as processors and memories. The network may include the Internet and/or other types of data networks, such as a local area network (LAN), a wide area network (WAN), a cellular network, satellite network, or other types of data networks.

In examples, database 919 may include one or more databases. In examples, database 919 may include an entity repository including a hierarchy of entity types. In examples, database 919 may include predetermined entity information categories for various entity types. In examples, database 919 may include information about entities, for example details about E-bikes.

In some aspects, the techniques described herein relate to a method, further including: providing focus to the application; and in response to selection of a control, displaying the user interface, wherein the application maintains focus during identification of the first content item and generation of the second content item.

In some aspects, the techniques described herein relate to a method, wherein the input area is a first input area and the second content item is provided to a second input area of the application.

In some aspects, the techniques described herein relate to a method, further including: displaying a control associated with a preview of the second content item in the user interface; and in response to selection of the control, providing the second content item to the application.

In some aspects, the techniques described herein relate to a method, further including: displaying, in the user interface, a control to recreate the first content item; and in response to receiving selection of the control, causing the model to generate third content using the first content item and the generation request.

In some aspects, the techniques described herein relate to a method, further including: displaying, in the user interface, a control for a content corpus; and in response to receiving selection of the control: identifying third content based on the content corpus, and causing a model to generate fourth content using the third content and the generation request.

In some aspects, the techniques described herein relate to a method, wherein identifying the first content item based on the content request further includes identifying the first content item from a content source upon receiving an indication that an option associated with the content source is selected.

In some aspects, the techniques described herein relate to a method, wherein identifying the first content item includes: determining a content category from the content request using at least one of a classifier or a generative model; and identifying the first content item by performing a search based on the content category.

In some aspects, the techniques described herein relate to a system, wherein the memory is further configured with code operable to: provide focus to the application; and in response to selection of a control, display the user interface, wherein the application maintains focus during identification of the first content item and generation of the second content item.

In some aspects, the techniques described herein relate to a system, wherein the input area is a first input area and the second content item is provided to a second input area of the application.

In some aspects, the techniques described herein relate to a system, wherein the memory is further configured with code operable to: display a control associated with a preview of the second content item in the user interface; and in response to selection of the control, display the second content item in the application.

In some aspects, the techniques described herein relate to a system, wherein the memory is further configured with code operable to: display a control in the user interface; and in response to receiving selection of the control, cause generation of third content.

In some aspects, the techniques described herein relate to a system, wherein the first content item is selected based on access attributes by the model using input that includes the first content item and the generation request.

In some aspects, the techniques described herein relate to a system, wherein the memory is further configured with code operable to: display, in the user interface, a control for a content corpus; and in response to receiving selection of the control: identify third content based on the content corpus, and cause a model to generate fourth content using the third content and the generation request.

In some aspects, the techniques described herein relate to a system, wherein identifying the first content item based on the content request further includes identifying the first content item from a content source upon receiving an indication that an option associated with the content source is selected.

In some aspects, the techniques described herein relate to a method, further including: in response to receiving selection of a control: identifying third content based on the content request; and causing generation of fourth content by a model using the third content and the generation request as input.

In some aspects, the techniques described herein relate to a method, wherein the second content item is provided to an input area of the application.

In some aspects, the techniques described herein relate to a method, wherein the first content item is selected based on access attributes.

In some aspects, the techniques described herein relate to a system, the memory further configured with code operable to: in response to receiving selection of a control: identify third content based on the content request; and cause generation of fourth content by a model using the third content and the generation request as input.

In some aspects, the techniques described herein relate to a system, wherein the first content item is selected for display based on access attributes.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. Various implementations of the systems and techniques described here can be realized as and/or generally be referred to herein as a circuit, a module, a block, or a system that can combine software and hardware aspects. For example, a module may include the functions/acts/computer program instructions executing on a processor or some other programmable data processing apparatus.

Some of the above example implementations are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks. In examples, a non-transitory computer-readable medium may store instructions that, when executed by a processor, cause a processor to execute portions of one or more methods discussed herein.

Specific structural and functional details disclosed herein are merely representative for purposes of describing example implementations. Example implementations, however, have many alternate forms and should not be construed as limited to only the implementations set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example implementations. As used herein, the term and/or includes any and all combinations of one or more of the associated listed items.

The terminology used herein is for the purpose of describing particular implementations only and is not intended to be limiting of example implementations. As used herein, the singular forms a, an, and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example implementations belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example implementations and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative implementations, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), Graphics Processing Units (GPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example implementations are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example implementations are not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or implementations herein disclosed irrespective of whether or not that particular combination has been specifically enumerated in the accompanying claims at this time.

What is claimed is:

1. A method comprising:
in response to receiving input in an input area of a user interface configured to provide content to applications, parsing the input to identify a content request and a generation request;
identifying a first content item based on the content request;
causing generation of a second content item by a model, which uses the first content item and the generation request as input; and
providing the second content item to an application.

2. The method of claim 1, further comprising:
providing focus to the application; and
in response to selection of a control, displaying the user interface, wherein the application maintains focus during identification of the first content item and generation of the second content item.

3. The method of claim 1, wherein the input area is a first input area and the second content item is provided to a second input area of the application.

4. The method of claim 1, further comprising:
displaying a control associated with a preview of the second content item in the user interface; and
in response to selection of the control, providing the second content item to the application.

5. The method of claim 1, further comprising:
displaying, in the user interface, a control to recreate the first content item; and
in response to receiving selection of the control, causing the model to generate third content using the first content item and the generation request.

6. The method of claim 1, further comprising:
displaying, in the user interface, a control for a content corpus; and
in response to receiving selection of the control:
identifying third content based on the content corpus, and
causing a model to generate fourth content using the third content and the generation request.

7. The method of claim 1, wherein identifying the first content item based on the content request further includes identifying the first content item from a content source upon receiving an indication that an option associated with the content source is selected.

8. The method of claim 1, wherein identifying the first content item comprises:
determining a content category from the content request using at least one of a classifier or a generative model; and
identifying the first content item by performing a search based on the content category.

9. A system comprising:
a processor; and
a memory configured with code operable to:
in response to receiving an input in an input area of a user interface configured to provide content to applications, parse the input to identify a content request and a generation request from the input;
identify first content item based on the content request;
cause generation of second content item by a model using input that includes the first content item and the generation request; and
provide the second content item to an application.

10. The system of claim 9, wherein the memory is further configured with code operable to:
provide focus to the application; and
in response to selection of a control, display the user interface, wherein the application maintains focus during identification of the first content item and generation of the second content item.

11. The system of claim 9, wherein the input area is a first input area and the second content item is provided to a second input area of the application.

12. The system of claim 9, wherein the memory is further configured with code operable to:
display a control associated with a preview of the second content item in the user interface; and
in response to selection of the control, display the second content item in the application.

13. The system of claim 9, wherein the memory is further configured with code operable to:
display a control in the user interface; and
in response to receiving selection of the control, cause generation of third content.

14. The system of claim 9, wherein the first content item is selected based on access attributes by the model using input that includes the first content item and the generation request.

15. The system of claim 9, wherein the memory is further configured with code operable to:
display, in the user interface, a control for a content corpus; and
in response to receiving selection of the control:
identify third content based on the content corpus, and
cause a model to generate fourth content using the third content and the generation request.

16. The system of claim 9, wherein identifying the first content item based on the content request further includes identifying the first content item from a content source upon receiving an indication that an option associated with the content source is selected.

17. A non-transitory computer-readable medium storing instructions that, when executed by a processor, cause the processor to:
in response to receiving an input in an input area of a user interface configured to provide content to applications, parse the input to identify a content request and a generation request from the input;
identify first content item based on the content request;
cause generation of second content item by a model using input that includes the first content item and the generation request; and
provide the second content item to an application.

18. A method comprising:
parsing an input to identify a content request and a generation request from the input;
identifying first content item based on the content request;
causing generation of second content item with a model using input including the first content item and the generation request; and
providing the second content item to an application.

19. The method of claim 18, further comprising:
in response to receiving selection of a control:
identifying third content based on the content request; and
causing generation of fourth content by a model using the third content and the generation request as input.

20. The method of claim 18, wherein the second content item is provided to an input area of the application.

21. The method of claim 18, wherein the first content item is selected based on access attributes.
